(19) United States
(12) Patent Application Publication
(10) Pub. No.: US 2021/0168697 A1
(43) Pub. Date: Jun. 3, 2021

(54) User Equipment and Method to Handle Access Barring

(71) Applicant: TELEFONAKTIEBOLAGET LM ERICSSON (PUBL), Stockholm (SE)

(72) Inventors: Pontus WALLENTIN, Linköping (SE); Jens BERGQVIST, Linköping (SE); Paul SCHLIWA-BERTLING, Ljungsbro (SE)

(73) Assignee: Telefonaktiebolaget LM Ericsson (publ), Stockholm (SE)

(21) Appl. No.: 17/044,991

(22) PCT Filed: Mar. 11, 2019
(86) PCT No.: PCT/SE2019/050212

§ 371 Date: Oct. 2, 2020

Related U.S. Application Data
(60) Provisional application No. 62/652,445, filed on Apr. 4, 2018.

(51) Int. Cl. H04W 48/08; H04W 76/27

(52) U.S. Cl. CPC H04W 48/08; H04W 76/27

(57) ABSTRACT

A method performed by a User Equipment (UE) for handling access barring in a wireless communications network is provided. The UE obtains (1201) barring instructions from a network node. The UE further performs (1204) access barring check. When the outcome of the access barring check is that the UE is not authorized, the UE determines (1205) how to proceed based on the barring instructions.

### TECHNICAL FIELD

Embodiments herein relate to a User Equipment (UE) and a method therein. In some aspects, they relate to handling access barring in a wireless communications network 100.

### BACKGROUND

In a typical wireless communication network, wireless devices, also known as wireless communication devices, mobile stations, stations (STA) and/or User Equipments (UE), communicate via a Local Area Network such as a WFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a WI-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

Access Control

When performing access to a wireless communication system, a UE must signal to the network that it wants to acquire communication opportunities. There are many schemes for how this may be done. For example, a UE may utilize air-interface resources, e.g., times, frequencies, to send a short message that would indicate to the network that a UE wants to communicate. Further details about a certain communication need may then occur in subsequent communication.

The event which triggers a UE to perform a request to access a wireless communication system may for example be a need for an application, such as a software module in the UE, to transmit uplink user data, and/or receive downlink user data. Or, a need to exchange signaling messages with a network node, or alternatively, a combination of both.

Consider a simplified wireless network 10 illustrated in FIG. 1, with a UE 12, which communicates with an access node 14, which in turn is connected to a network node 16.

For wireless communication systems pursuant to 3GPP E-UTRAN/LTE standard specifications, the access node 14 corresponds typically to an Evolved NodeB (eNB) and the network node 16 corresponds typically to either a Mobility Management Entity (MME) and/or a Serving Gateway (SGW).

In 3GPP LTE, a request for communication is performed by initiating a random access procedure followed by a Radio Resource Control (RRC) Connection Establishment procedure. Please see FIG. 2 depicting a Random access and RRC connection establishment in 3GPP LTE.

This sequence starts with a transmission of a Random Access Preamble 201, also known as “msg1”, on specifically allocated channels or resources. This random access preamble is, when received by a base station or eNB, followed by a random access response 202, also known as “msg2” that includes an allocation of resources for continued signaling, in this case the RRC Connection Request 203, also known as “msg3” which is the first message in the RRC Connection Establishment procedure.

As is easily realized, an access attempt will cost air interface resources. Both the initial message 201, Preamble as well as resources for further signaling 202-205 will add to the wireless network load, simply to configure and setup communication resources for subsequent data transfer. It should be noted that even further communication is needed with network entities before any communication can take place, these are omitted from FIG. 2.

Under certain circumstances, it is desirable to prevent UE's from making these access attempts. For example, in case of an overload situation like radio resource congestion or shortage of processing capabilities, a network may wish to reduce overload by denying access to a cell. The network may also need to prioritize between specific users, such as UEs, and/or services during overload situations. For example, to give priority to emergency calls compared to ordinary calls.

To this end, the network may employ what is in 3GPP referred to as access control. Access Class Barring (ACB) is an example of one such control. In short, access barring is about preventing or making it less likely that a UE will attempt to send an access request, e.g., to initiate the sequence above by sending a preamble, 201. In this way, the total load in the system can be controlled. The network may for example divide UE's or different reasons for why a UE want access into different classes, or categories and dependent on this, the network can differentiate and make it less likely that, e.g., certain UE's and/or certain events trigger access requests. For example, a given UE may belong to a certain access class and the network may communicate, via broadcasted system information, that certain classes at certain instances are barred, i.e., not allowed to make access, or allowed to make access with a lower probability if not barred altogether. When a UE receives this broadcasted system information, if it belongs to a barred access class, it may result in that a UE will not send an access request. There are multiple variants of access barring mechanisms specified for LTE.

1. Access Class Barring (ACB) as per 3GPP Release 8: In this mechanism, it is possible to bar all access requests from a UE. Normal UEs in Access Class (AC) range 0-9 are barred with a probability factor, also referred to as barring factor, and a timer, also referred to as barring duration, whereas specific classes can be controlled separately. Beside the normal classes 0-9, additional classes have been specified to control the access to other type of users, e.g. emergency services, public utilities, security services, etc.

2. Service Specific Access Control (SSAC): The SSAC mechanism allows a network to prohibit Multi-Media Telephony (MMTel)-voice and MMTel-video accesses from a UE. The network broadcasts barring parameters, parameters similar to ACB, and a barring algorithm that is similar to ACB, barring factor and random timer. An actual decision if access is allowed is done in the IP Multi-Media Subsystem (IMS) layer of a UE.

3. Access control for Circuit-Switched FallBack (CSFB): The CSFB mechanism allows a network to prohibit CSFB users. A barring algorithm used in this case is similar to ACB.

4. Extended Access Barring (EAB): The EAB mechanism allows a network to prohibit low priority UEs. Barring is based on a bitmap in which each access class (AC 0-9) can be either barred or allowed.

5. Access class barring bypass: The ACB mechanism allows omitting access class barring for IMS voice and video users.

6. Application specific Congestion control for Data Communication (ACDC) barring: ACDC allows barring of traffic from/to certain application. In this solution, applications are categorized based on global application identification (ID) (in Android or iOS). The network broadcasts barring parameters (barring factor and timer) for each category.)

All the variants of access control operate for UEs in idle mode prior to random access and RRC connection establishment. SSAC additionally can be applied also for connected mode UEs, i.e. UEs in RRC_CONNECTED state in LTE.

In LTE, before a UE performs access towards an access node, it needs to read certain system information that is usually broadcast by the network node 110. The system information describes how access should be performed to initiate communication between the UE 102 and the access node 104. Part of this system information may be information related to access barring. This barring information is usually broadcasted in the access network 10 and there may be different barring information in different cells or areas. Usually, one access node 14 will transmit its own barring information. The barring information may be arranged in a way such that it includes a set of access categories [1 . . . m] and for each category, information elements containing a barring factor and a barring time, for example as specified in 3GPP TS 36.331 v.14.1.0, 2016-12, see text below, illustrating an example of ACDC access barring information for LTE.

BarringPerACDC-Category-r13 ::= SEQUENCE {

| | |
|---|---|
| acdc-Category-r13 | INTEGER (1..maxACDC-Cat-r13), |

| | |
|---|---|
| acdc-BarringConfig-r13 | SEQUENCE { |

| | |
|---|---|
| ac-BarringFactor-r13 | ENUMERATED { |

p00, p05, p10, p15, p20, p25, p30, p40,
p50, p60, p70, p75, p80, p85, p90, p95},

| | |
|---|---|
| ac-BarringTime-r13 | ENUMERATED {s4, s8, s16, s32, s64, s128, |

s256, s512}

| | |
|---|---|
| } | OPTIONAL -- Need OP |

}

This barring information per access category will be used by the UE attempting access and it is a way for the access node to limit and prioritize certain accesses over other.

3GPP System Architecture

FIG. 3 depicts Planes in a communications system. A communication system, such as a 3GPP system, is normally functionally divided vertically into User Plane 401, Control Plane 402 and Management Plane 403 as illustrated in FIG. 3. This division allows independent scalability, evolution and flexible deployments. The user plane 401, which carries the user data traffic, contains functions and protocols related to user data transfer such as segmentation, reassembly, retransmission, multiplexing, ciphering and so forth. In the control plane 402, which carries signalling traffic, we find the protocols and functions needed to setup, release, control and configure the user plane. The control plane 402 also contains functions and protocols related to for example UE mobility, UE authentication, control of user sessions and bearers, also known as service data flows or QoS flows. In the Management plane 403, which carries administrative traffic, there is found for example operations and maintenance (O&M) and provisioning functions. There exists normally no distinct division between the control plane 402 and that management plane 403 but typically the control plane 402 operates in a faster time scale, e.g. seconds, than the management plane 403, e.g. hours. Then the User Plane 401 operates typically in the fastest time scale, e.g. in milliseconds.

FIG. 4 depicts domains and strata in a 3GPP system and illustrates another division of the 3GPP system, into domains and strata. A stratum is a grouping of protocols related to one aspect of the services provided by one or several domains. There are a number of domains, most important are the UE 12, the Access Network (AN) 502 and the Core Network (CN) 503. It needs to be understood that typically the UE 12, AN 502 and CN 503 all contains User Plane 401, Control Plane 402 and Management Plane 403 functions.

The UE 12 is a device allowing a user access to network services. It is typically a wireless terminal, such as a smartphone, equipped with a User Services Identity Module (USIM). The latter contains the credentials in order to unambiguously and securely identify itself. The functions of the USIM may be embedded in a stand-alone smart card, but may also be realized, e.g., as software in a software module.

The AN 502, also known as the RAN, comprises access nodes, or base stations, also known as eNBs or gNBs, which control the radio resources of the access network and provides the UE 12 with a mechanism to access the core network 503. The Access Network 502 is dependent of the radio access technology used in the wireless interface between the UE 12 and Access Network 502. Thus, there are different flavors of access networks 502 for different radio access technologies, such as E-UTRAN supporting LTE or E-UTRA radio access technology and NG-RAN supporting New Radio (or 5G) type of radio access technology.

The CN 503 comprises network nodes which provide support for the network features and telecommunication services, such as the management of user location information, control of network features and services, the switching and transmission of signaling and user data. The core network 503 also provides an interface towards the External Network 507. There are different types of core networks 503, for different 3GPP system generations. For example, in 4G, also known as the Evolved Packet System (EPS), there is the Evolved Packet Core (EPC). Developed as part of the 5G System (5GS) there is the 5G Core (5GC).

Moreover, the core network 503 is access-agnostic and the interface between the access network 502 and core network 503 enables integration of different 3GPP and non-3GPP access types. Agnostic when used refers to something that is generalized so that it is interoperable among various systems. For example, an Access Network 502, also known as E-UTRAN, supporting LTE or E-UTRA radio access technology as well as an access network, also known as NG-RAN, supporting New Radio type of radio access technology may both be connected to a 5G type of core network 503, also known as 5G Core (5GC).

The External Network 507 represents here a network outside of the 3GPP domain, such as the public Internet.

As seen in FIG. 4, 3GPP system is also horizontally divided into the access Stratum (AS) 504 and Non-Access Stratum (NAS) 505 reflecting a protocol layering hierarchy. In the AS 504 there are functions which are related to the wireless portion of the system such as transport of data over the wireless connection and managing radio resources. The AS 504 typically comprises functions in the access network 502 and the dialogue, using corresponding protocols, between the UE 12 and the access network 502. In the NAS 505, which may be seen as higher in the protocol layering hierarchy than AS 504, there are the functions which are not directly dependent on the radio access technology and typically the functions in the core network and the dialogue, using corresponding protocols, between the UE 12 and the core network 503.

In FIG. 4, also the Application 506 is illustrated above NAS 505. The Application 506 may comprise parts in the UE 12, the core network 503 and the External network 507.

FIG. 5 depicts protocol layers in user plane and control plane of a 3GPP system. The control plane 402 and User Plane 401 of the Access Stratum 504 and Non-Access Stratum 505 are further divided into protocol layers. As illustrated in FIG. 5, in the AS 504, there is one protocol layer in the control plane 402, namely the Radio Resource Control (RRC) layer 601. As the RRC layer 601 is part of the Access Stratum 504, it is dependent on the type of radio access technology used between the UE 12 and Access Network 502. Thus, there are different flavors of RRC 601 for different radio access technologies, e.g. one type of RRC layer 601 for each of UTRA, E-UTRA and New Radio type of radio access technologies.

Further, in the Access Stratum 504 there are also a number of protocol layers in the user plane 401, such as the Physical (PHY) layer 611, Medium Access Control (MAC) layer 612, Radio Link Control (RLC) layer 613 and Packet Data Convergence Control (PDCP) layer 614.

For New Radio, we also expect a new layer in the AS 504, above PDCP 614, here denoted New Layer (NL) 615.

All protocol layers, both in the User Plane 401 and Control Plane 402 of the Access Stratum 504 are terminated in the Access Network 502 in the network side, such as the eNB or the gNB.

In the NAS 505, there are multiple protocol layers in the control plane 402. In Evolved Packet System (EPS), also known as 4G or LTE, these layers are known as EPS Mobility Management (EMM) 603 and EPS Session Management (ESM) 604. In the 5G system, we will find protocol layers performing the equivalent functions of EMM 603 and ESM 604, such as the Connection Management (CM) 605.

Further, in the NAS 505, there are multiple protocol layers in the user plane 401, such as the Internet Protocol (IP) 616.

The Application 506 resides above the NAS 505, and interacts with the user plane 401 and in some cases also the control plane 402.

UE States and State Transitions

In the 3GPP system, for each protocol layer there is a state machine, reflecting the UE states of the particular protocol layer. In the state machine of the RRC layer 601 for NR radio access technology, according to 3GPP TS 38.804 v14.0.0 (2017-03), three states are specified as illustrated in FIG. 6: RRC_IDLE 701, RRC_INACTIVE 702 and RRC_CONNECTED 703. FIG. 6 depicts RRC states for NR.

The RRC states reflect the UE's activity level where RRC_IDLE 701 is typically used when the UE has no ongoing data traffic, thus no activity, and RRC_CONNECTED 703 when the UE needs to send and/or receive data. RRC_INACTIVE 702 may be used as an alternative state instead of RRC_IDLE 701 when the UE has no or low activity.

The procedure to enter RRC_CONNECTED 703 from RRC_IDLE 701 is known as the “RRC connection establishment” procedure. Before the RRC connection establishment the UE will be subject to Access control, including an access barring check as described above.

A UE in RRC_CONNECTED 703 will typically after a while, typically by order of a network node, such as the gNB, transit to RRC_INACTIVE 702, due to inactivity, using what is known as the “RRC Inactivation” procedure. Then, after even longer period of inactivity it will again enter RRC_IDLE 701 using e.g. the RRC Connection Release procedure. A UE in RRC_INACTIVE 702 needs to again enter RRC_CONNECTED 703 in order to transmit or receive data. Alternatively, the UE may remain in Inactive for as long as it remains in a certain network area, or it may be paged by the network to transition from RRC_INACTIVE 702 to RRC_IDLE 701.

The procedure for entering RRC_CONNECTED 703 from RRC_INACTIVE 702 is sometimes referred to as an “RRC Resume” or “Activation” procedure. The RRC Resume procedure is currently being standardized and details are yet to be set, but it is expected to require much less signaling than the RRC connection establishment procedure, since e.g. processing resources, transport resources and security association in the network are preserved in RRC_INACTIVE 702 and thus there is typically no need to establish those in the RRC Resume procedure. Therefore the latency before user data can be exchanged between the UE and the network is typically much shorter for a UE in RRC_INACTIVE 702 than for a UE in RRC_IDLE 701. On the other hand, a UE in RRC_INACTIVE 702 consumes a little more power as well as resources, e.g. memory, than a UE in RRC_IDLE 701.

For LTE, a similar RRC state machine is specified and the functionality similar to the NR RRC_INACTIVE state as well as an RRC Resume procedure already exists.

Unified Access Control in 3GPP

An ongoing evolution of the access control mechanisms, in particular for 5th generation cellular standards according to 3GPP, is to gather the existing access control mechanisms into one single mechanism that can be configurable and adaptable to various network operator preferences. It has thus been agreed that 5G will include a single access control framework, what is known as Unified access control.

Unified access control will apply to UEs accessing 5G Core via NR or E-UTRA/LTE. Moreover, Unified access control is applied in all UE states, whereas for LTE, with one exception, SSAC, the access control mechanisms only apply for idle mode UEs.

Unified access control is currently being specified in 3GPP TS 22.261 referring to 5G service requirements, 3GPP TR 24.890 referring to 5G system core network CT1 aspects, 3GPP TS 36.300 referring to RAN stage 2. CT1 is a Working Group responsible for the 3GPP specifications that define the User Equipment—Core network Layer three (L3) radio protocols and Core network side of the Iu reference point.

According to the solutions being discussed in 3GPP, the access node, e.g. gNB or eNB, indicates barring condition for each cell using access barring parameters to UEs, by system information broadcast in the RRC layer within the Access Stratum (AS). This barring condition makes it able to prevent UEs from accessing the network using relevant barring parameters that vary depending on Access Identity and Access Category.

Further, in the UE, there is a process which detects what is known as “access attempts” defined in 3GPP TS 22.261. An access attempt is an event which triggers the UE to request access the network, such as to setup an RRC connection in RRC_IDLE state, or a new session request in RRC_CONNECTED state, such as a new PDU session or an MMTEL Voice call. For each detected access attempt one or more Access Identities and only one Access Category are selected.

Access Identities are configured at the UE and are typically used for “special” UEs, such as UEs for mission-critical services or for operator use. In TS 22.261, the access identities are being specified as illustrated in Table 1 below.

| Access Identity | |
|---|---|
| number | UE configuration |
| 0 | UE is not configured with any parameters from this table |
| 1 (NOTE 1) | UE is configured for Multimedia Priority Service (MPS). |
| 2 (NOTE 2) | UE is configured for Mission Critical Service (MCS). |
| 3-10 | Reserved for future use |
| 11 (NOTE 3) | Access Class 11 is configured in the UE. |
| 12 (NOTE 3) | Access Class 12 is configured in the UE. |
| 13 (NOTE 3) | Access Class 13 is configured in the UE. |
| 14 (NOTE 3) | Access Class 14 is configured in the UE. |
| 15 (NOTE 3) | Access Class 15 is configured in the UE. |

(NOTE 1):
Access Identity 1 is used to provide overrides according to the subscription information in UEs configured for MPS. The subscription information defines whether an overide applies to UEs within one of the following categories:
a) UEs that are configured for MPS;
b) UEs that are configured for MPS and are in the PLMN listed as most preferred PLMN of the country where the UE is roaming in the operator-defined PLMN selector list or in their HPLMN or in a PLMN that is equivalent to their HPLMN;
c) UEs that are configured for MPS and are in their HPLMN or in a PLMN that is equivalent to it.
(NOTE 2):
Access Identity 2 is used to provide overrides according to the subscription information in UEs configured for MCS. The subscription information defines whether an overide applies to UEs within one of the following categories:
a) UEs that are configured for MCS;
b) UEs that are configured for MCS and are the PLMN listed as most preferred PLMN of the country where the UE is roaming in the operator-defined PLMN selector list or in their HPLMN or in a PLMN that is equivalent to their HPLMN;
c) UEs that are configured for MCS and are in their HPLMN or in a PLMN that is equivalent to it
(NOTE 3):
Access Identities 11 and 15 are valid in Home PLMN only if the EHPLMN list is not present or in any EHPLMN. Access Identities 12, 13 and 14 are valid in Home PLMN and visited PLMNs of home country only. For this purpose the home country is defined as the country of the MCC part of the IMSI.

Access Categories are defined by the combination of conditions related to UE and the type of access attempt. In TS 22.261, the access categories are being specified as illustrated in Table 2 below:

| Access Category | | |
|---|---|---|
| number | Conditions related to UE | Type of access attempt |
| 0 | All | MO signalling resulting from |
| | | paging |
| 1 (NOTE 1) | UE is configured for delay tolerant service and | All except for Emergency |
| | subject to access control for Access Category 1, | |
| | which is judged based on relation of UE's HPLMN | |
| | and the selected PLMN. | |
| 2 | All | Emergency |
| 3 | All except for the conditions in Access Category 1. | MO signalling resulting from |
| | | other than paging |
| 4 | All except for the conditions in Access Category 1. | MMTEL voice |
| 5 | All except for the conditions in Access Category 1. | MMTEL video |
| 6 | All except for the conditions in Access Category 1. | SMS |
| 7 | All except for the conditions in Access Category 1. | MO data that do not belong to |
| | | any other Access Categories |
| 3-31 | | Reserved standardized Access |
| | | Categories |
| 32-63 (NOTE 2) | All | Based on operator classification |

(NOTE 1):
The barring parameter for Access Category 1 is accompanied with information that define whether Access Category applies to UEs within one of the following categories:
a) UEs that are configured for delay tolerant service;
b) UEs that are configured for delay tolerant service and are neither in their HPLMN nor in a PLMN that is equivalent to it;
c) UEs that are configured for delay tolerant service and are neither in the PLMN listed as most preferred PLMN of the country where the UE is roaming in the operator-defined PLMN selector list on the SIM/USIM, nor in their HPLMN nor in a PLMN that is equivalent to their HPLMN.
(NOTE 2):
When there are an Access Category based on operator classification and a standardized Access Category to both of which an access attempt can be categorized, and the standardized Access Category is neither 0 nor 2, the UE applies the Access Category based on operator classification. When there are an Access Category based on operator classification and a standardized Access Category to both of which an access attempt can be categorized, and the standardized Access Category is 0 or 2, the UE applies the standardized Access Category.

As illustrated in Table 2 there are up to 32 standardized access categories (0-8, 9-31), and up to 32 operator-defined access categories (32-63). How to select the standardized access categories are specified as rules in the standard. On the other hand, the rules for how to select the operator-defined access categories are configured by the network. Each of these configured rules will be used as one criterion for selecting a particular operator-defined access category. An example of a criterion is that an access attempt associated with a PDU session for a certain value of Data Network Node (DNN) is mapped to a certain operator-defined access category. Each rule is associated with precedence, used to prioritize in which order the UE evaluates the rules.

This means that when selecting the appropriate access category for a given access attempt, the UE selects either a standardized access category or an operator-defined access category, in a deterministic way based on specified and configurable rules.

Definition of the access attempts, for each access category, is now being done by 3GPP working groups, mainly CT1 and RAN2. It is understood that access attempts may be detected and identified in several layers in the UE, including 5G Session Management (5GSM), 5G Mobility Management (5GMM), SMS over Internet Protocol (SMSolP), Multimedia Telephony (MMTEL) and Radio Resource Control (RRC). But “double barring” should be avoided and therefore a given access attempt should only detected at one place in the protocol stack, and only once.

Typically, the layer which detects the access attempt performs the mapping to access category, triggers access barring check and performs enforcement of blocking the attempt if not authorized.

The overall procedure for unified access control is illustrated in FIG. 7, referring also to FIG. 1.

In a first step 1001, a network node optionally provides rules for the operator-specific access categories. This information is illustrated as originating from the network node 16 but may very well also originate from other network nodes and be transmitted to the UE 12 via network node 16 or possibly via another node, e.g. an operator's policy functionality configuring the UE 12 via a Wireless Local Area Network (WLAN) access network. If the network includes a higher-level controller or policy functionality it may originate from another node hosting such controller or policy functionality. The higher layer rules may be signalled to the UE 12 via Non-Access-Stratum (NAS) signalling, or it may be signalled using other protocols. For example, the UE 12 may include an entity that may be configured with and host access category rules signalled using an OMA-DM device management protocol.

Included in the rules from the network node 16, may be information related to for example, how a UE should select access category if the access is triggered by a certain service. Examples of such services may be for example an emergency service or an MMTel Service. Further, the rules may include information related to how a UE 12 should select access category if an access is triggered by a certain application, such as, e.g., a certain game or a certain social media application. Rules may also include information related to access to various slices. For example, a small device-UE 12, may want to access, e.g., an Internet of Things (IoT)-optimized slice. Further, it is not uncommon that radio networks are shared between different operators or that one and the same operator is using different Public Land Mobile Network (PLMN) codes. There may be different rules for selecting access category dependent on if access is to occur for different PLMN's.

It should be noted that step 1001 may also include signalling from the access node 14, in particular when it comes to access category selection for accesses that are triggered by, e.g., signalling with the access node.

When an event occurs triggering a need for the UE 12 to request an access to the network, such as a need to transmit uplink data when the UE 12 is in idle mode, or to setup an MMTel Voice call when the UE 120 is in RRC_CONENCTED state, the UE 12 first detects whether this event is an access attempt in step 1002. An access attempt would always undergo access barring check before it is allowed. Some events are not classified and detected as access attempts. For example, when uplink data is to be sent for an existing PDU session in RRC_CONNECTED state.

If the event was classified and detected as an access attempt, the UE 12 determines the access category in step 1003, based on the standardized rules as well as any configured rules obtained in step 1001.

After determining the access category for this particular access attempt, the UE 120 then reads access barring information typically part of the broadcasted system information in step 1004. Typically the UE 12 is required to maintain the latest version of the broadcasted system information which implies that the UE 120 in many cases does not actually have to re-read the system information and instead can use cached system information.

The UE 12 then performs an access barring check in step 1005, using the determined access category and the access barring information as input.

If the outcome of barring check is “authorized” the UE 12 will continue and perform the access in step 1006, resulting typically in an uplink signalling message such as an RRC connection request or a NAS message such as a PDU Session Request, depending on the UE state and the type of access attempt.

On the other hand, if the outcome of barring check is “not authorized” the UE 12 will not perform an access and instead wait for a period, such as by starting a timer with a value indicated in the access barring information.

The development of a unified access control mechanism for access barring is currently ongoing. Access attempts are being defined in 3GPP, in particular in the CT1 and RAN2 groups, and being specified in 3GPP TS 24.501 and TS 38.331.

The access control and in particular the barring mechanisms are used to prevent UE's from sending an access request. There are also other mechanisms available for controlling the load in the network. For example, in situations when access barring allows an access attempt and a UE is allowed to send a Preamble 201 and an RRC Connection Request, 203 or any equivalent message, also known as “msg3” the network may anyway respond with an RRC Connection Reject message. The reasons for this reject message may for example be, e.g., an overload situation that is not yet reflected on in the parameters governing the access barring. It may also be other reasons.

### SUMMARY

As a part of developing embodiments herein a problem was identified by the inventors and will first be discussed.

In the recent developments of unified access control in 3GPP, access attempts are being specified. One particular problem is the barring of uplink signaling messages to be sent by the UE.

For example, TS 22.261 defines access category 3 to be used for “MO Signalling” types of access attempts. One example of an “Mobile Originated (MO) Signalling” type of access attempt would be initiation of a 5GMM Registration Procedure. Another example would be initiation of a RAN update procedure. Yet another example would be a Measurement Report message.

In case of the access attempt not being authorized, as part of the barring check for the access category used by the particular access attempt, the UE will block this access attempt. This is true also for access attempts of type “Mobile Originated (MO) signaling”, i.e. access category 3. A problem with blocking these attempts is that these messages are important for the system itself, and not triggered by a human or an end-user operated application. For example, if the UE cannot initiate a 5G MM registration procedure such as a Tracking Area Update procedure when it shall, this will cause a conflict with existing procedure specifications, e.g. UE becomes unreachable or potentially implicitly detached from the system.

Therefore, typically those “error cases” would need to be specified, i.e. what the UE need to do when an uplink signaling message cannot be transmitted, due to access barring. A method typically used, is that the UE enters idle mode. A main drawback is that since the access barring check is based on probability, i.e. when barring is applied for an access category it means e.g. 50% probability for barring. The network cannot know if a particular UE is barred in this example. If a UE goes to idle, without having the possibility to inform the network due to barring, the UE and the network do have an inconsistency, or at least an uncertainty from network side, about the UE state. Also, it may be beneficial if the network has a possibility to control the UE behavior, since different UE behavior on access barring may be desirable depending on scenario and/or type of network overload.

In recent 3GPP discussions there have also been raised proposals to add a way to efficiently release multiple UEs in a cell, e.g. in case of network overload situations. In case of network overload, to send separate release messages to each individual UE may seem too costly in case of e.g. a processor or a downlink radio resource being overloaded. One proposal to solve this would be to rather use a single paging message or some other type of broadcast or multicast signaling message to order multiple UEs to go to idle mode. The common issue with these proposals is that this opens up the possibility for e.g. Denial of Service (DoS) attacks with a false network, e.g. using a false base station, illegally releasing all UEs within an area covered by this false network.

Thus, there is a need for:
A method to efficiently prohibit UE signaling messages due to access barring.
A method to avoid uncertainty about the UE state in the network.
A method to control the UE behavior from the network in case of uplink signaling messages are barred.
A method for releasing a number of UEs in an efficient way during e.g. overload situations.

An object of embodiments herein is therefore to improve the performance of the network such as a wireless communications network.

According to an aspect of embodiments herein, the object is achieved by a method performed by a User Equipment, UE, for handling access barring in a wireless communications network. The UE obtains barring instructions from a network node. The UE further performs access barring check. When the outcome of the access barring check is that the UE is not authorized, the UE determines how to proceed based on the barring instructions.

According to another aspect of embodiments herein, the object is achieved by User Equipment, UE, for handling access barring in a wireless communications network. The UE is configured to:
obtain barring instructions, from a network node 110,
perform access barring check, and
when the outcome of the access barring check is that the UE 120 is not authorized, determine how to proceed based on the barring instructions.

This is an advantage provided by embodiments herein since the network such as the network node 110 may dynamically control how UEs such as the UE 120 behave when barring check results in “not authorized” by providing barring instructions, rather than a fixed behaviour which is stated in specifications . . . .

### BRIEF DESCRIPTION OF THE FIGURES

FIG. 1 is a schematic block diagram illustrating prior art.

FIG. 2 is a sequence diagram illustrating prior art.

FIG. 3 is a schematic block diagram illustrating prior art.

FIG. 4 is a schematic block diagram illustrating prior art.

FIG. 5 is a schematic block diagram illustrating prior art.

FIG. 6 is a schematic block diagram illustrating prior art.

FIG. 7 is a sequence diagram illustrating prior art.

FIG. 8 is a schematic block diagram illustrating embodiments of a wireless communications network.

FIG. 9 is a flowchart depicting embodiments of a method in a UE.

FIG. 10 is a flowchart depicting embodiments of a method.

FIG. 11 is a flowchart depicting embodiments of a method.

FIG. 12 is a schematic block diagram illustrating embodiments of a UE.

FIG. 13 schematically illustrates a telecommunication network connected via an intermediate network to a host computer.

FIG. 14 is a generalized block diagram of a host computer communicating via a base station with a user equipment over a partially wireless connection.

FIGS. 15-18 are flowcharts illustrating methods implemented in a communication system including a host computer, a base station and a user equipment.

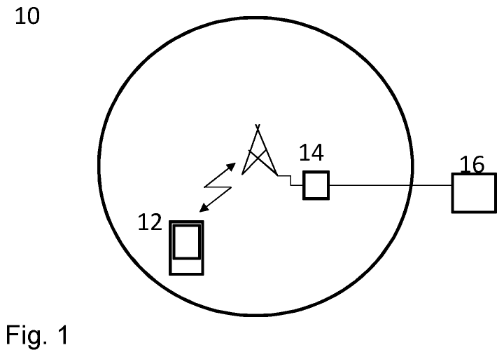

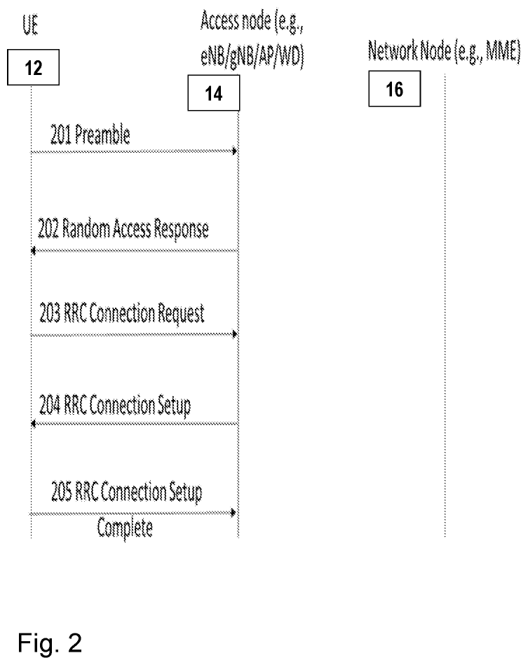

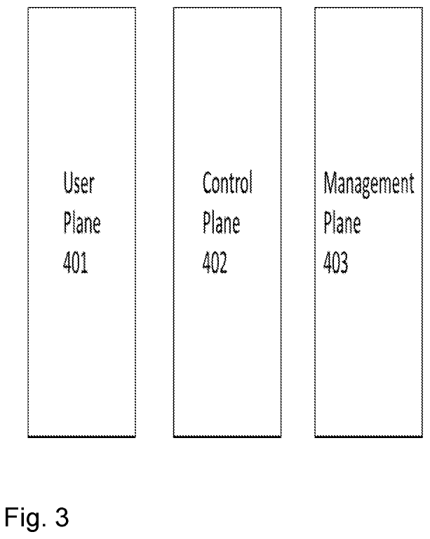

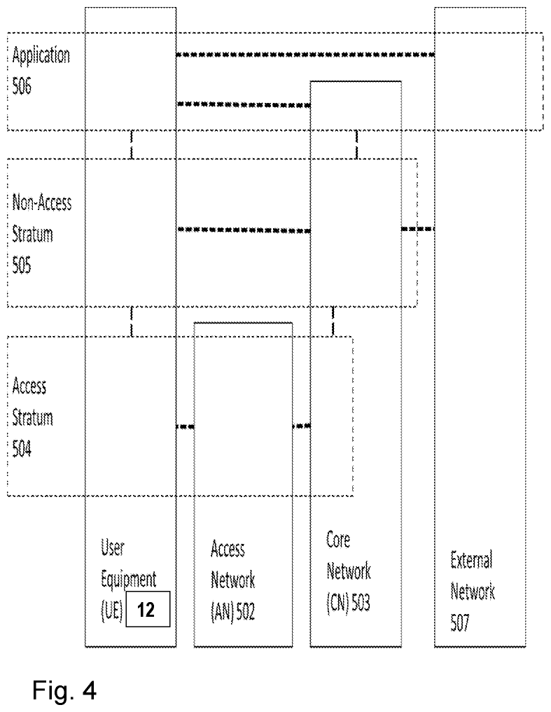

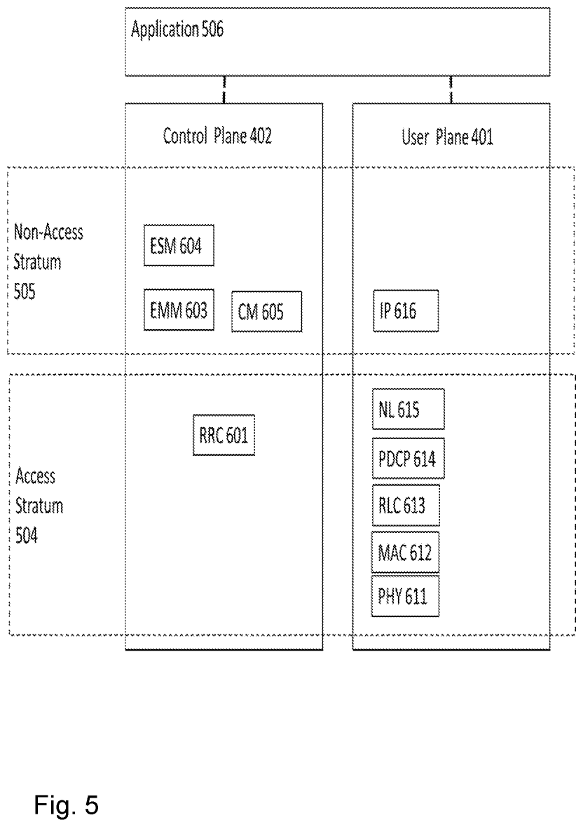

### DETAILED DESCRIPTION

Embodiments herein relate to wireless communication systems such as cellular networks. A method, user equipment and network nodes for transmitting and receiving messages related to wireless access are disclosed.

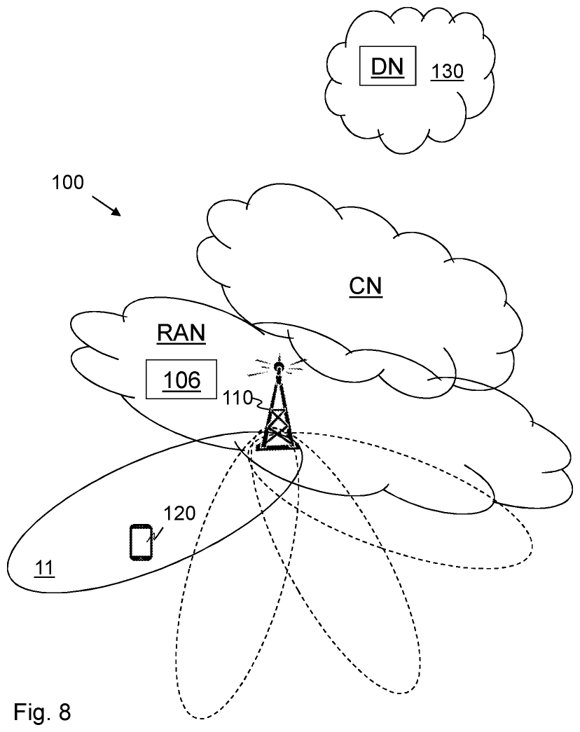

Examples of embodiments herein relate to wireless communication networks in general. FIG. 8 is a schematic overview depicting a wireless communications network 100. The radio communications network 100 comprises one or more RANs and one or more CNs. The radio communications network 100 may use a number of different technologies, such as Long Term Evolution (LTE), LTE-Advanced, 5G, New Radio (NR), be a radio communications network pursuant to 3GPP LTE/EUTRA specifications, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 100, wireless devices e.g. a UE 120 such as a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The radio communications network 100 comprises a network node 110 providing radio coverage over a geographical area, a service area 11, which may also be referred to as a beam or a beam group of a first radio access technology (RAT), such as 5G, LTE, Wi-Fi or similar. The network node 110 may be a transmission and reception point e.g. an access node such as a radio access node, a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the service area served by the network node 110 depending e.g. on the first radio access technology and terminology used. The network node 110 may be referred to as a serving radio network node and communicates with the UE 120 with Downlink (DL) transmissions to the UE 120 and Uplink (UL) transmissions from the UE 120.

Methods for handling such as e.g. controlling access the wireless communications network 100, is performed by the UE 120. As an alternative, a Distributed Node (DN) and functionality, e.g. comprised in a cloud 130 as shown in FIG. 8 may be used for performing or partly performing the methods.

The technology described herein may be used in various wireless systems and is not restricted to 3GPP EUTRA/LTE systems and 3GPP Next Generation systems deploying New Radio, even though such systems will serve as examples. Access control is a mechanism that may be applicable to any system where user, service or other differentiation and load management of access is needed. Other examples may be wireless access pursuant to IEEE 802 standards, such as IEEE 802.11 WLAN standard or the IEEE 802.16 standard, but also 3GPP GSM evolutions.

### Actions of Some Embodiments Herein

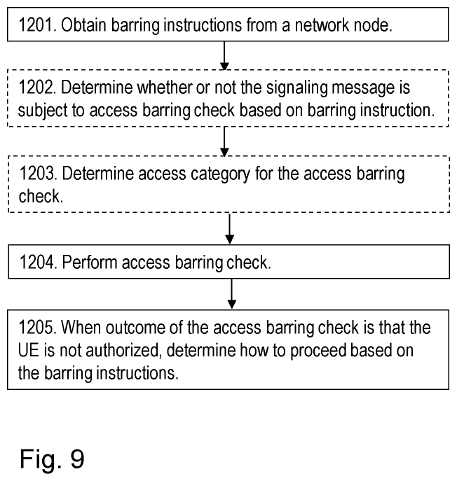

Example embodiments of a flowchart illustrating embodiments of a method performed by the UE 120, e.g. for handling access barring also referred to as access control, in the wireless communications network 100, is depicted in FIG. 9 and will shortly be described in the following. The method comprises one or more of the following actions which actions may be taken in any suitable order.

In order for the network such as the network node 110 to control access barring it may send barring instructions to the UE 120. This is different from the ordinary barring configuration as performed in prior art in that the barring instruction includes information related to actions to be performed by the UE 120. This is different from the rules provided in the operator-defined access categories, which are only used to select access category. This is also different from the access barring information provided in system information, which only provides information used to determine whether access categories are barred or not. Thus in Action 1201, the UE 120 obtains barring instructions from the network node 110. The network node 100 may e.g. may be an access node. The barring instructions may in some embodiments be comprised in a message that may need a response from the UE 120. This is since typically, many signalling procedures are initiated from the network such as the network node 110 with a signalling message sent to the UE 120, and the UE 120 shall respond by transmitting a message back to the network.

In Action 1202 relating to some embodiments, the UE 120 determines based on the barring instruction, whether or not a signalling message is subject to an access barring check.

This may e.g. be a signalling message that the UE 120 is about to trigger to be transmitted. This may be determined since depending on network load, some signalling messages should be prioritized. This may e.g. be messages that relates to access attempts which already have undergone an access barring check. One such example is e.g. the UE 120 when it has an ongoing emergency call that has already been authorized and should not be subject to certain subsequent access barring checks.

In other words, this may be determined since depending on network load, some signalling messages should be prioritized, e.g. messages that relates to access attempts which already have undergone an access barring check, such as e.g. UE 120 which has an ongoing emergency call that has been authorized will not be subject to certain subsequent access barring checks.

In Action 1203 relating to some embodiments, the UE 120 determines access category for the access barring check. This may be determined as the network such as the network node 110 provides access barring information for each access category, and access categories may be barred independently. By selecting access category a differentiation between barring of e.g. signalling messages is provided.

In Action 1204, the UE 120 then performs access barring check. This may e.g. be performed when the signalling message is to be transmitted. The performing of the access barring check based on the determined access category may be performed when the signalling message is an attempt to access the wireless communications network 1000, e.g. referred to as access attempt.

This is to see whether the signalling message is allowed to be sent or not, based on the access barring information provided by the network for the access categories. Thus, in case of e.g. a network overload, a disaster situation, or network maintenance, access categories may be barred, resulting in barring checks to be “not authorized”.

In the embodiments where the UE 120 has determined access category for the access barring check, the UE 120 may perform the access barring check based on the determined access category.

In Action 1205, when the outcome of the access barring check is that the UE 120 is not authorized, the UE 120 determines how to proceed based on the barring instructions.

The UE 120 not being authorized may comprises that the UE 120 is not authorized to send the signalling message.

This is an advantage provided by embodiments herein since the network such as the network node 110 may dynamically control how UEs such as the UE 120 behave when barring check results in “not authorized” by providing barring instructions, rather than a fixed behaviour which is stated in specifications. For example, in case of a severe overload or a disaster, the network such as the network node 110 may instruct the UEs such as the UE 120 to go to idle mode or selecting another system, and in some embodiments without sending messages to each UE individually. These instructions are comprised in the barring instructions that the UE has obtained from the network node 110.

How to proceed based on the barring instructions is in some embodiments determined according to any one out of:

When the barring instruction is set to ignore, determining to not transmit the message,

when the barring instruction is set to wait and retry, determining to wait during a period according to the barring instruction and then perform a further access barring check,

when the barring instruction is set to go to idle, determining to enter idle stat such as e.g. RRC_IDLE state,

when the barring instruction is set to fail, determining to fail a signalling procedure,

when the barring instruction is set to go to inactive, determining to enter RRC_INACTIVE state, and

when the barring instruction is set to reselect another of any one out of: cell, frequency and system, determining to re-select to another of any one out of: cell, frequency and system.

Example steps of some embodiments. It should be noted that terms action and step may be used interchangeably.

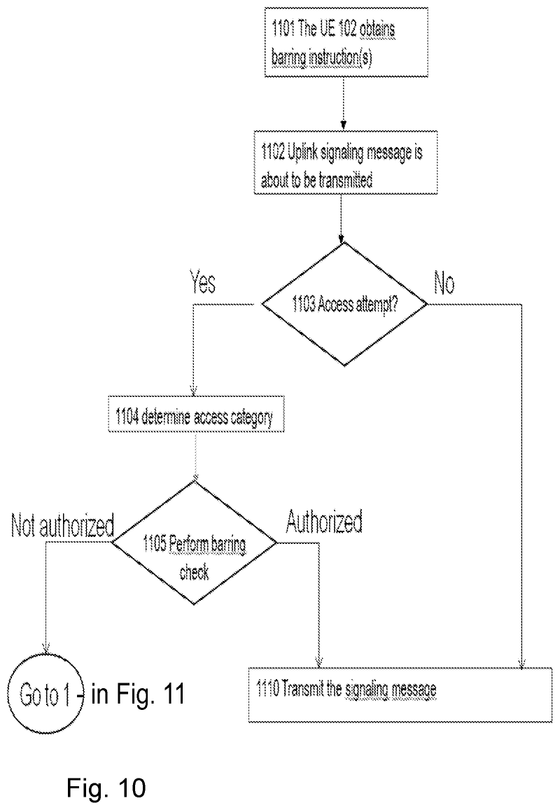

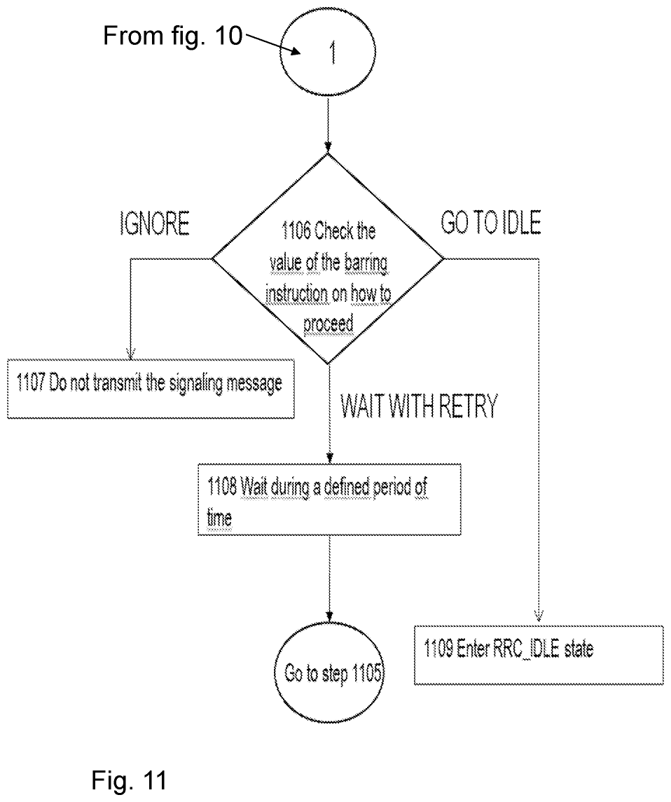

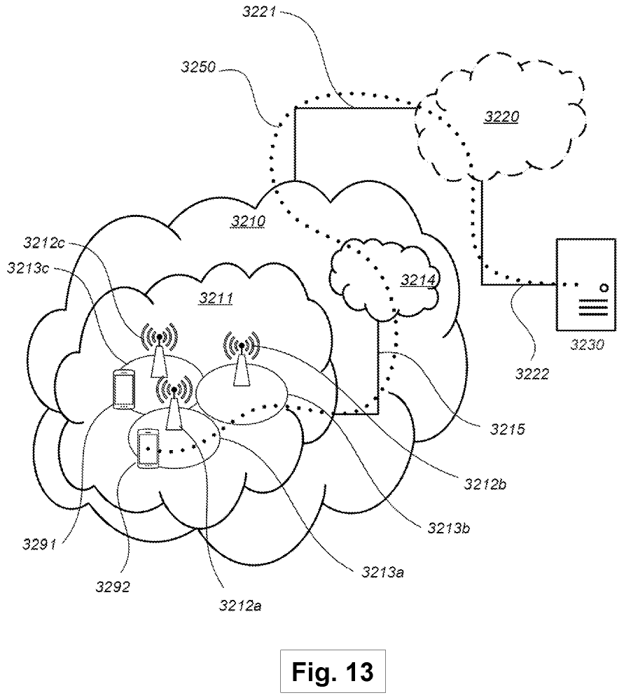

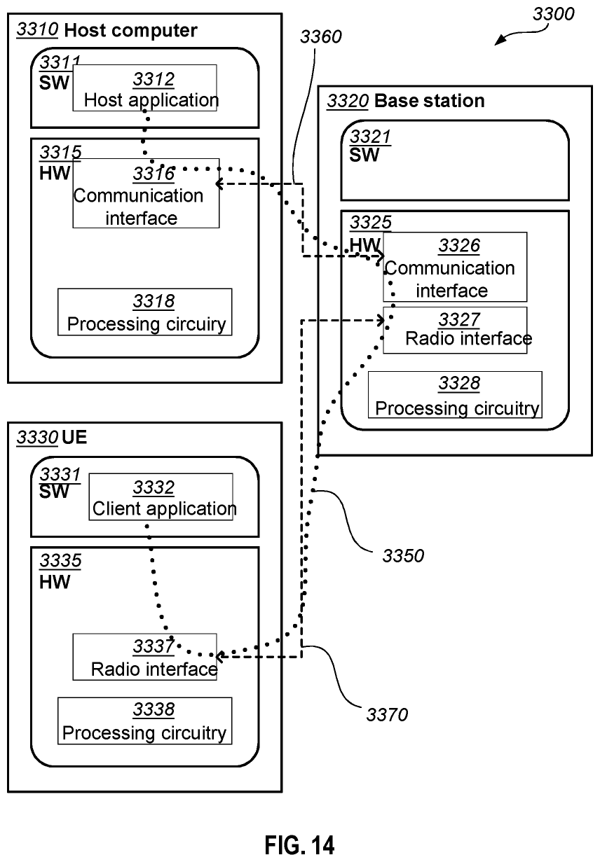

Some example steps performed by the UE 120 are illustrated in FIG. 13-14 whereof the steps 1101-1105 and 1110 are depicted in FIG. 10, and steps 1106-1109 are depicted in FIG. 11.

In step 1101, the UE 120 obtains one or multiple barring instructions, e.g. one barring instruction per access category.

In step 1102, an uplink signaling message is about to be transmitted by the UE 120.

In step 1103, the UE 120 uses the barring instruction to determine whether this uplink signaling message is identified as an access attempt. If not identified (No), the UE 120 proceeds to transmit the message in step 1110.

If this uplink signaling message is identified as an access attempt (Yes), the UE 120 determines an access category in step 1104, possibly by using the barring instruction, and performs access barring check in step 1105.

If outcome of the access barring check is “Authorized” the UE 120 proceeds to transmit the message in step 1110.

If outcome of the access barring check is “Not Authorized” the UE 120 in step 1106, see FIG. 11, uses the barring instruction to determine how to proceed.

If the barring instruction is set to IGNORE, the UE 120 in step 1107 does not transmit the message.

If the barring instruction is set to WAIT WITH RETRY, the UE 120 in step 1108 waits during a period (according to the barring instruction) and goes back to step 1105 and performs another access barring check.

If the barring instruction is set to GO TO IDLE, the UE 120 in step 1109 enters RRC_IDLE state.

Embodiments herein will now be described more in detail and be exemplified which may be combined in any suitable way with any of the embodiments above.

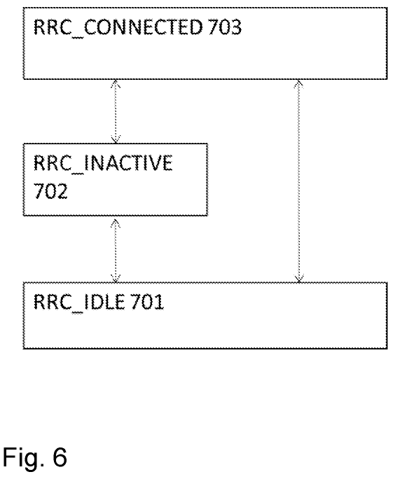

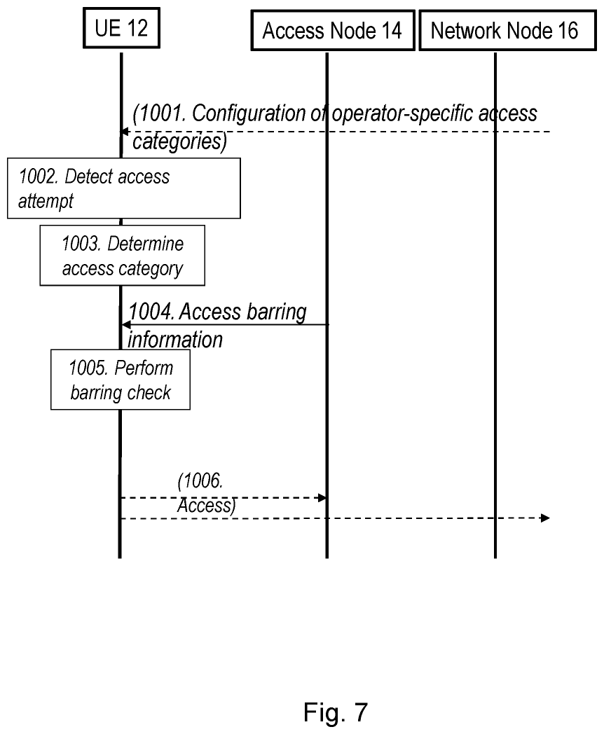

When the UE 120 is about to trigger an uplink signaling message, such as an RRC message, this signaling message transmission may be subject to be identified as an access attempt and therefore a barring check may be performed using the procedure as illustrated in FIG. 6 for unified access control. In other words, the UE 120 may determine access identities and an access category and may then perform an access barring check using the determined access category and broadcasted system information containing access barring information.

Whether a particular uplink signaling message is identified as an access attempt is either stated in a specification or alternatively provided as configuration information to the UE 120.

When outcome of the access barring check is “Authorized”, the UE 120 may transmit the uplink signaling message.

On the other hand, if the outcome of the access barring check is “Not authorized”, the UE 120, will according to embodiments herein, proceed according to a barring instruction provided by the network, e.g. as part of the access barring information in system information.

The barring instruction indicates how the UE 120 shall proceed e.g. IGNORE, WAIT with RETRY, GO to IDLE. Each barring instruction may be applicable to signalling protocol, procedure, UE state and/or message.

When an uplink signaling message becomes “Not authorized” the UE 120 checks whether a barring instruction is applicable, e.g. for the UE state, protocol, procedure and message.

The barring instruction may also indicate whether a barring check should be performed for the specific message and/or which access category to use.

If barring check results in “not authorized” the UE 120 acts according to the instruction value. How to deal with retransmissions may also be part of the instruction. Whether to perform barring check on reply may be indicated per message basis.

The barring instruction may also be transmitted on per-UE basis, and even as part of e.g. a reconfiguration message, such as RRC Connection Reconfiguration, which includes an instruction on how to deal with the response to this particular reconfiguration message in case barring is applied. For example, this may be part of operator-defined access categories.

In an alternative embodiment, an access barring check by the UE 120 is triggered unrelated to any identified new access attempt, e.g. sending a paging message to the UE 120, e.g. notification that system info has changed, an explicit, dedicated message to the UE 120, or using a timer, e.g. when this timer expires, access barring check is triggered, and timer is started again when the access barring check outcome is “Authorized”.

When the network performs barring of an access category, the result that a signaling message can't be send due to that being barred forces the UE 120 to go Idle mode. Both UEs in RRC_CONNECTED and RRC_INACTIVE state may be released this way.

Embodiments herein may provide at least the following advantages:

When the network such as a wireless communications network, applies barring of one or several access category(ies) as indicated in access barring information, multiple UE's will go to idle mode in some cases when RRC messages are triggered. Also RRC_INACTIVE UEs can be released this way. This is an efficient way of releasing many UEs, with minimal load on network entities, and thus preventing more load on an already overloaded network.

Embodiments herein efficiently prohibit transmission of signaling messages from UEs to the network.

Embodiments herein may also ensure that any barred signaling messages to cause a deterministic behavior, as it is controlled by the network, and this behavior may be configured depending on the scenario.

### Alternative Embodiments

The trigger of access barring check may be performed also by indicating so in a message sent from the network such as the network node 110 to the UE 120. For example, by sending a barring indication as part of a paging indication or system information message, all UEs receiving this such as the UE 120, e.g. all UEs in a certain cell, will trigger an access barring check. For example, the reception of a paging message may trigger the read of system information where the barring indication is included. In another example, the access barring check is triggered in a single UE such as the UE 120, by a dedicated message sent from the network node 110 to this UE 120.

The barring instruction may indicate whether the UE 120 should perform access barring check for a given signaling message, or all messages, to be transmitted. For example, when the barring instruction is included in a message sent to the UE 120, which requires a reply back to the network such as the network node 110, this barring instruction may indicate if barring check should be performed on the reply message by the UE 120.

The barring instruction may indicate which access category to use by the UE 120 when performing access barring check before the UE 120 transmits a signaling message. For example, when the barring instruction is included in a message sent to the UE 120, which requires a reply back to the network, this barring instruction may indicate which access category to use in the corresponding access barring check.

The barring instruction may indicate FAIL, meaning that the procedure which triggered the access attempt and transmission of a signaling message by the UE 120, shall fail. For example, when the barring instruction is included in a signaling message sent to the UE 120, which requires a reply back to the network, this barring instruction may indicate that when barring check before sending the reply message results in “Not authorized”, the procedure will fail and the UE 120 shall revert back to be state and/or configuration it had before receiving the signaling message.

In one example, the barring instruction is included in a Measurement Configuration message to the UE 120, and is used by the UE 120 prior to send measurement reports.

The barring instruction may also indicate GO TO RRC_INACTIVE, implying that the UE 120 shall enter RRC_INACTIVE state 702, in case access barring check results in “Not authorized”.

The barring instruction may also indicate that the UE shall re-select to another cell, frequency and/or system.

In case the barring instruction indicates WAIT WITH RETRY, the network may either indicate the time period for the UE 120 to wait as part of the barring instruction, or, as alternative.

The barring instruction may indicate how to deal with retransmissions. For example, it may indicate that if access barring check results in “Not authorized” before sending a signaling message, any retransmissions of this signaling messages should also be barred and not transmitted.

The access barring check may be triggered by a timer. The timer may be started by the UE 120 upon reception of a message, a state transition, or transmission of a message. The timer value may be provided in the barring instruction. When the timer expires, the UE 120 performs an access barring check according to the barring instruction.

The examples may apply on signaling messages and procedures, such as RRC or NAS messages, transmitted by a UE 120. The same embodiments may also be applied to other information to be sent by the UE 120, such as user data, RLC packets, Service Data Adaptation Protocol (SDAP) packets, MAC PDUs, IP packets. For example, the barring instruction may be applied on a MAC resynchronization procedure, such as whether the UE 120 shall perform access barring check before initiating this procedure and/or which access category to use and how to handle the case when access check results in “Not authorized”.

The barring instruction may also indicate on which protocol layer and/or protocol entity (identified as protocol instance, bearer and/or logical channel) that is affected by the barring instruction.

The method for access barring may be performed in a UE, e.g. characterized by
obtaining a barring instruction from an access node;
performing access barring check when a signaling message is to be transmitted;
using the barring instruction when responding to the access barring check.

Wherein the UE 120 may enter idle mode when the access barring check result is “not authorized”.

Wherein the barring instruction may be used to determine if the signaling message is subject to access barring check.

Wherein the barring instruction may be used to determine access category for the access barring check;

Referring again to in FIG. 8, which may illustrate the wireless communications network 100, for example being pursuant to 3GPP LTE/EUTRA specifications.

In the wireless network 100 the UE 120 is illustrated. The UE 120 may request access to and communicate with the network node 110. The network node 110 is typically part of an access network such as a RAN. The network node 110 may in turn be connected to a network node 106, typically part of the core network CN, that for example may provide internet access. In LTE, the network node 110 is commonly referred to as eNB, whereas in other standards, it may be referred to as Node B, Base Station, or simply Access Point. In the development of next generation radio access technology for 5G in 3GPP, also known as “New Radio”, the network node 110 is sometimes referred to as “gNB”. It should be noted that the illustration in FIG. 8 is traditional in the sense that it provides a view of “physical entities”, but to a person skilled in the art, it should be obvious that for example the network node 110 or the network node 106 may be implemented using distributed or centralized processing capacity such as using what is also known as Network Function Virtualization (NFV). Similarly, they may also be implemented in the same physical entity. For purposes of this example, the description will associate the nodes with certain functionality rather than restricting to certain implementations.

The network node 110 may communicate user information and signalling to and from the network node to the UE 120. The Wireless network 100 comprises in this FIG. four “cell” areas and one network node 110. It should be understood that any access network usually comprises several access nodes and thus several more areas or cells are thus served.

The network node 106 may be one of many nodes part of the core network CN. For example it may be a control plane node, e.g., an Mobility Management Entity (MME), in LTE, a Core Access and Mobility Management Function/Session Management Functions (AMF/SMF) according to 3GPP system architecture as specified in e.g. 3GPP TS 23.102 or 3GPP TS 23.501), for communicating control information with the UE 120, or it may be a user plane node Serving Gateway (SGW), or a User Plane Function (UPF) as specified in e.g. 3GPP TS 23.102 or 3GPP TS 23.501, for communicating user data information to the UE 120. Further, the network node 130 may be connected with other network nodes and work as a relay for information from these nodes to the UE. Such other network nodes may for example be a Packet Gateway (PGW) or similar.

The UE 120 may be in a valid combination of RRC state and NAS layer state. For example, in case of a 5G core network and a new radio type of access network and corresponding access node and network node, the UE may be in RRC_INACTIVE state and CM-CONNECTED state, or alternatively in RRC_CONNECTED and CM-CONNECTED. It should be understood that the UE may also be in RRC_IDLE and CM-IDLE.

For the detailed description embodiments herein, it may be assumed that the UE 120 may be connected to the network node 106 part of a 5G core network via a network node 110 part of an NR access network, also known as NG-RAN. It should be understood that a person skilled in the art is able to apply embodiments herein for other systems than 5G/NR, such as an UE connected to a network node 106 in a 5G core network or the EPC, via a network node 110 part of an LTE access network.

For the detailed description of embodiments herein, we as the example here also assume the UE 120 is in the RRC_INACTIVE and CM-CONNECTED states. It should be understood that a person skilled in the art will be able to apply embodiments herein also in another combination of UE states, such as RRC_CONNECTED and CM-CONNECTED.

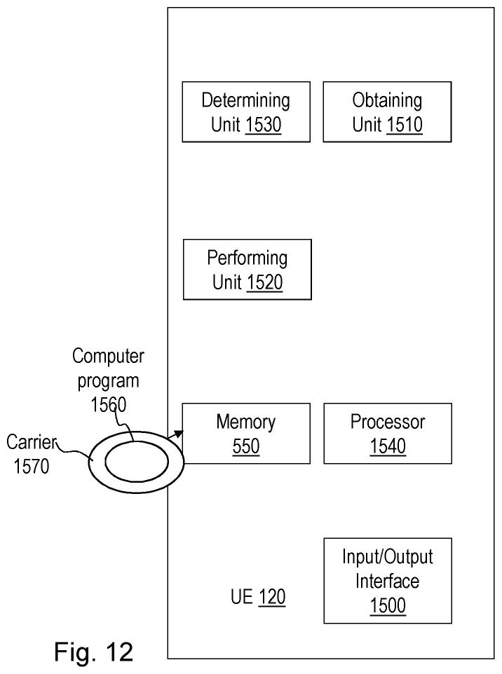

To perform the method actions the UE 120 may comprise the arrangement depicted in FIG. 12.

The UE 120 may comprise an input and output interface 1500 configured to communicate with the network node 110. The input and output interface may comprise a wireless receiver not shown) and a wireless transmitter not shown).

To perform the method actions as mentioned above, the UE 120 may comprise an obtaining unit 1510, a performing unit 1520, and a determining unit 1530, as shown in FIG. 12.

The embodiments herein may be implemented through a respective processor or one or more processors, such as the processor 1540 of a processing circuitry in UE 120 depicted in FIG. 12, together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise a memory 1550 comprising one or more memory units. The memory 1550 comprises instructions executable by the processor in UE 120.

The memory 1550 is arranged to be used to store e.g. barring instructions, information, data, configurations, and applications to perform the methods herein when being executed in the UE 120.

In some embodiments, a respective computer program 1560 comprises instructions, which when executed by the respective at least one processor 1550, cause the at least one processor 1550 of the UE 120 to perform the actions above.

In some embodiments, a respective carrier 1560 comprises the respective computer program 1550, wherein the carrier 1560 is one of an electronic signal, an optical signal, an electromagnetic signal, a magnetic signal, an electric signal, a radio signal, a microwave signal, or a computer-readable storage medium.

Those skilled in the art will also appreciate that the units in the UE 120, described above and below may refer to a combination of analog and digital circuits, and/or one or more processors configured with software and/or firmware, e.g. stored in the UE 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

Some example Embodiments numbered 1-14 are described below. The following embodiments refer among other things to FIG. 8, FIG. 9 and FIG. 12.

Embodiment 1. A method performed by a User Equipment, UE, 120 e.g. for handling access barring, e.g. access control, in a wireless communications network 100, the method comprising any one or more out of:
obtaining 1201 barring instructions, e.g. in a message that may need a response, from a network node 110, e.g. an access node,
performing 1204 access barring check e.g. when a signalling message is to be transmitted,
when the outcome of the access barring check is that the UE 120 is not authorized, determining 1205 how to proceed based on the barring instructions.

Embodiment 2. The method according embodiment 1, further comprising:
determining 1202 whether or not the signalling message is subject to access barring check, based on the barring instruction.

Embodiment 3. The method according any of the embodiments 1-2, further comprising:
determining 1203 access category for the access barring check, and
wherein the performing 1204 of the access barring check is based on the determined access category.

Embodiment 4. The method according any of the embodiments 1-3, wherein the performing 1204 of the access barring check is based on the determined access category is performed when the signalling message is an attempt to access the wireless communications network 100, e.g. referred to as access attempt.

Embodiment 5. The method according any of the embodiments 1-4, wherein the UE 120 is not authorized comprises that the UE 120 is not authorized to send the signalling message.

Embodiment 6. The method according to any of the embodiments 1-5, wherein how to proceed based on the barring instructions is determined according to any one out of:

When the barring instruction is set to ignore, determining 1205 to not transmit the message,
when the barring instruction is set to wait and retry, determining 1205 to wait during a period according to the barring instruction and then perform a further access barring check,
when the barring instruction is set to go to idle, determining 1205 to enter idle stat such as e.g. RRC_IDLE state,
when the barring instruction is set to fail, determining 1205 to fail a signalling procedure,
when the barring instruction is set to go to inactive, determining 1205 to enter RRC_INACTIVE state, and
when the barring instruction is set to reselect another of any one out of: cell, frequency and system, determining 1205 to re-select to another of any one out of: cell, frequency and system.

Embodiment 7. A computer program comprising instructions, which when executed by a processor, causes the processor to perform actions according to any of the embodiments 1-6.

Embodiment 8. A carrier comprising the computer program of embodiment 7, wherein the carrier is one of an electronic signal, an optical signal, an electromagnetic signal, a magnetic signal, an electric signal, a radio signal, a microwave signal, or a computer-readable storage medium.

Embodiment 9. A User Equipment, UE, 120 e.g. for handling access barring, e.g. access control, in a wireless communications network 100, the UE 120 being configured to any one or more out of:
obtain barring instructions, e.g. in a message that may need a response, from a network node 110, e.g. an access node, e.g. by means of an obtaining unit 1510 in the UE 120,
perform access barring check e.g. when a signalling message is to be transmitted, e.g. by means of an performing unit 1520 in the UE 120
when the outcome of the access barring check is that the UE 120 is not authorized, determine how to proceed based on the barring instructions, e.g. by means of a determining unit in the UE 120.

Embodiment 10. The UE 120 according embodiment 9, further being configured to e.g. by means of the determining unit 1530 in the UE 120:
determine whether or not the signalling message is subject to access barring check, based on the barring instruction.

Embodiment 11. The UE 120 according any of the claims 9-10, further being configured to:
determine access category for the access barring check, e.g. by means of the determining unit in the UE 120 and
perform the access barring check by basing it on the determined access category, e.g. by means of the performing unit in the UE 120.

Embodiment 12. The UE 120 according any of the embodiments 9-11, wherein the UE 120 further is configured to, e.g. by means of the performing unit in the UE 120, perform the access barring check based on the determined access category by perform it when the signalling message is an attempt to access the wireless communications network 100, e.g. referred to as access attempt.

Embodiment 13. The UE 120 according any of the embodiments 9-12, wherein the UE 120 not being authorized is adapted to comprise that the UE 120 is not authorized to send the signalling message.

Embodiment 14. The UE 120 according to any of the embodiments 9-13, wherein how to proceed based on the barring instructions is adapted to be determined, e.g. by means of the determining unit in the UE 120, according to any one out of:

When the barring instruction is set to ignore, determine to not transmit the message,
when the barring instruction is set to wait and retry, determine to wait during a period according to the barring instruction and then perform a further access barring check,
when the barring instruction is set to go to idle, determine to enter idle stat such as e.g. RRC_IDLE state,
when the barring instruction is set to fail, determine to fail a signalling procedure,
when the barring instruction is set to go to inactive, determine to enter RRC_INACTIVE state, and
when the barring instruction is set to reselect another of any one out of: cell, frequency and system, determine to re-select to another of any one out of: cell, frequency and system.

### Further Extensions and Variations

With reference to FIG. 13, in accordance with an embodiment, a communication system includes a telecommunication network 3210 e.g. a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212. Any of the UEs 3291, 3292, may e.g. be the UE 120.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: such as data rate, latency, power consumption and thereby provide benefits such reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

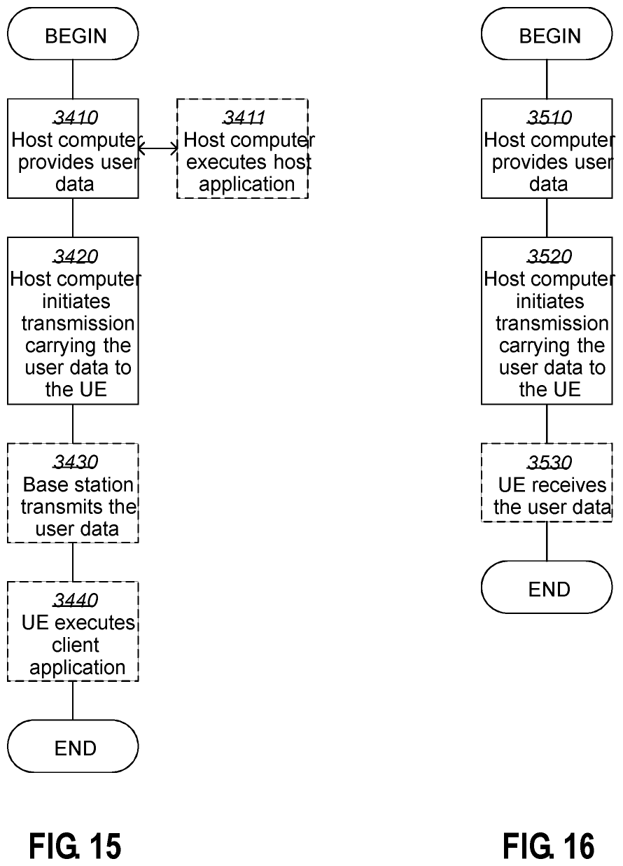

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 15 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 16 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

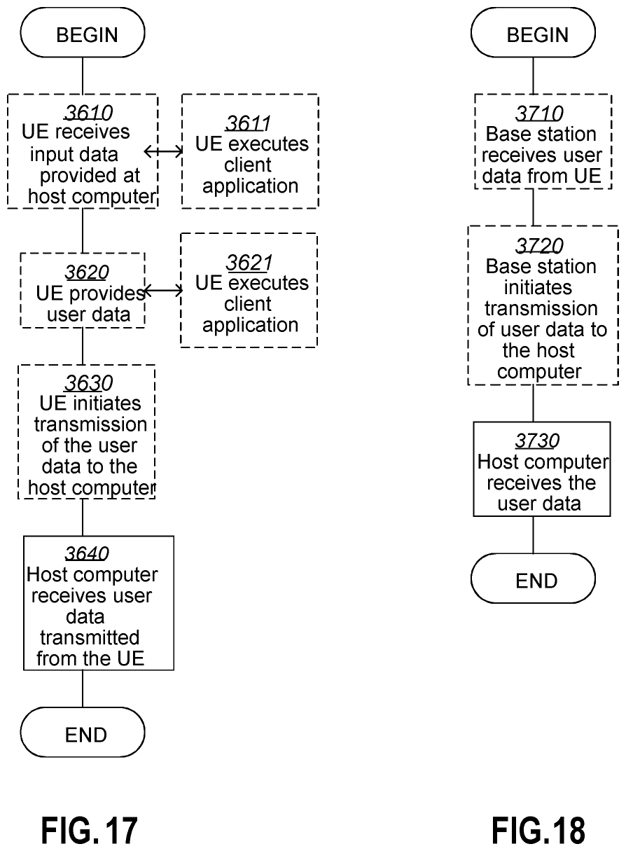

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 17 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 18 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATION EXPLANATION

5GS 5G System
AN Access Network
AN Access Node
EPS Evolved Packet System
AS Access Stratum
NAS Non-Access Stratum

1-14. (canceled)

15. A method performed by a User Equipment (UE) for handling access barring in a wireless communications network, the method
obtaining barring instructions from a network node;
performing access barring check; and
when the outcome of the access barring check is that the UE is not authorized, determining how to proceed based on the barring instructions.

16. The method of claim 15, further comprising:
determining whether or not a signaling message is subject to access barring check, based on the barring instruction.

17. The method of claim 15, further comprising:
determining access category for the access barring check, and
wherein the performing of the access barring check is based on the determined access category.

18. The method of claim 15, wherein the performing of the access barring check is performed when a signaling message is an attempt to access the wireless communications network.

19. The method of claim 15, wherein the UE is not authorized comprises that the UE is not authorized to send a signaling message.

20. The method of claim 15, wherein how to proceed based on the barring instructions is determined according to any one out of:
when the barring instruction is set to ignore, determining to not transmit the message.
when the barring instruction is set to wait and retry, determining to wait during a period according to the barring instruction and then perform a further access barring check.
when the barring instruction is set to go to idle, determining to enter idle state,
when the barring instruction is set to fail, determining to fail a signalling procedure,
when the barring instruction is set to go to inactive, determining to enter RRC_INACTIVE state, and
when the barring instruction is set to reselect another of any one out of: cell, frequency and system, determining to re-select to another of any one out of: cell, frequency and system.

21. A non-transitory computer-readable medium comprising, stored thereupon, a computer program comprising instructions that, when executed by a processor, cause the processor to perform the method of claim 15.

22. A User Equipment (UE) for handling access barring in a wireless communications network, the UE being configured to:
obtain barring instructions, from a network node;
perform access barring check; and
when the outcome of the access barring check is that the UE is not authorized, determine how to proceed based on the barring instructions.

23. The UE of claim 22, further being configured to:
determine whether or not a signaling message is subject to access barring check, based on the barring instruction.

24. The UE according claim 22, further being configured to:
determine access category for the access barring check, and
perform the access barring check by basing it on the determined access category.

25. The UE according claim 22, wherein the UE further is configured to, perform the access barring check based on the determined access category when a signaling message is an attempt to access the wireless communications network.

26. The UE according claim 22, wherein the UE not being authorized is that the UE is not authorized to send a signaling message.

27. The UE of claim 22, wherein how to proceed based on the barring instructions is determined according to any one out of:
when the barring instruction is set to ignore, determine to not transmit the message.
when the barring instruction is set to wait and retry, determine to wait during a period according to the barring instruction and then perform a further access barring check.
when the barring instruction is set to go to idle, determine to enter idle state,
when the barring instruction is set to fail, determine to fail a signaling procedure,
when the barring instruction is set to go to inactive, determine to enter RRC_INACTIVE state, and
when the barring instruction is set to reselect another of any one out of: cell, frequency and system, determine to re-select to another of any one out of: cell, frequency and system.
